(19) United States
(12) Patent Application Publication
(10) Pub. No.: US 2012/0304482 A1
(43) Pub. Date: Dec. 6, 2012

(54) METHOD FOR DRYING FLEXIBLE TUBULAR CASINGS BY MICROWAVES

(75) Inventors: Andreas Willers, Walsrode (DE); Hartmut Fuhrmann, Walsrode (DE)

(73) Assignee: CASETECH GMBH, Bomlitz (DE)

(21) Appl. No.: 13/578,227

(22) PCT Filed: Jan. 11, 2011
(86) PCT No.: PCT/EP2011/000072

§ 371 Date: Aug. 9, 2012

(30) Foreign Application Priority Data
Feb. 10, 2010 (DE) 10 2010 007 658.9

(51) Int. Cl. F26B 3/347

(52) U.S. Cl. 34/259

(57) ABSTRACT

The present disclosure relates to a method for drying flexible tubular casings by microwaves, in particular for drying coated or uncoated food casings, and also to the use of microwaves for drying such casings. In addition, the invention relates to an integrated system for producing and drying flexible tubular casings by microwaves.

The present invention relates to a method for drying flexible tubular casings by microwaves, in particular for drying coated or uncoated food casings, and also to the use of microwaves for drying such casings. In addition, the invention relates to an integrated system for producing flexible tubular casings and drying them by microwaves.

Flexible tubular casings in general, including the food casings preferably considered here, can be produced by various methods. In the case of food casings, in particular sausage casings, the expression artificial skins is also used. Various production methods for artificial skins are known. For instance, they can be produced from cellulose hydrate, from vegetable parchment, from a protein-coated woven fabric backbone, from collage or else from plastic.

In the case of cellulose-based skins, a distinction is made between skins produced homogeneously from cellulose and those which are reinforced with wet-strength fibres, termed fibrous skins. In addition, there are also fibrous skins having an additionally applied PVDC layer, which offers advantages in certain applications. A survey of the various artificial-skin production variants may be found in “Wursthüllen Kunstdarm” [Sausage casings artificial skin], chapter 4, “Herstellung des Kunstdarmes” [Production of the artificial skin], pages 47 to 63, Deutscher Fachverlag, 2006.

In all of the abovementioned methods, a drying step takes place at one or more points in the production process. For example, there are typically two drying steps in the dry spinning method in the production of collagen skin. In the wet-spinning method, which is technically similar in the production of collagen skin and cellulose skin, before the respective skin is wound up, generally a concluding drying step takes place (cf. “Wursthüen Kunstdarm”, chapter 4, “Herstellung des Kunstdarmes”, pages 47 to 63, Deutscher Fachverlag, 2006.

The individual drying steps in the various production processes can proceed in each case in a different manner. Typical drying methods operate with hot air, wherein the air, for example, can be heated by gas burners and is then blown onto the skin passing through.

However, the customarily used drying methods frequently have significant disadvantages. For instance, drying by hot air proceeds on the respective artificial skin section from the outside to the inside, i.e. the warm air first warms the artificial skin from the outside, which leads to an evaporation of moisture and then continues to the inside. This is therefore accompanied by a time delay until the inner layers of the artificial skin are warmed and can begin to dry. Although, in order to make up for the time delay, it would be conceivable to increase the temperature further, this could lead to local overheating of the outer layers, which could likewise be disadvantageous for the artificial skin. For example, the locally overheated artificial skin can be insufficiently flexible during the further processing to sections and shirred product and can be mechanically damaged. This can lead to bursting during sausage production. In addition, overheated artificial skin can have poorer shrinkage properties and reduced permeabilities in the production of raw sausage. In order to achieve a good and safe drying result here, manufacturers are forced to reduce the velocity of the artificial skin web which passes through. This clearly leads to a lower production capacity of an artificial skin system. It has been found that the drying steps are in fact a limiting factor for output of finished product in artificial skin production.

There is therefore a requirement for the manufacturers of artificial skins to accelerate the drying step and thereby eliminate what is known as the bottleneck. At the same time, the drying must be gentle to the material and also favourable from the aspect of energy usage.

Therefore, it was the object of the present invention to provide a faster and better drying method for flexible tubular casings, in particular for food casings, that are produced by a wet skin method.

This object is achieved in a manner according to the invention by the method specified in Claims 1 to 11, by a system defined in Claims 12 to 14 and by the use cited in Claims 15 and 16.

The invention therefore first relates to a method for drying flexible tubular casings, characterized in that the flexible tubular casing that is to be dried is conducted through a microwave system that generates microwaves.

According to the method according to the invention, it is preferred that the flexible tubular casing that is to be dried is a coated or uncoated food casing. In this method either an uncoated moist food casing, a moist coating of a food casing moist per se, or a moist food casing provided with a moist coating can be dried by the microwaves of the microwave system.

Particularly preferred flexible tubular casings that are dried according to the method according to the invention are those that were produced in a wet skin process. Examples of such flexible tubular casings are cellulose fibre skin casings, cellulose skin casings and collagen skin casings.

The method according to the invention typically envisages that the flexible tubular casing that is to be dried is conducted continuously in an integrated production and drying process, after production thereof, through a microwave system, which is open on at least two sides, and is dried in the course of this.

In the drying mode of the microwave system, the temperature within the microwave system can be in the range between 0 and 200° C. and typically between 20 and 100° C. The flexible tubular casing is dried in this process primarily by the microwaves. By operating the microwave system at relatively high temperatures, the drying can be accelerated. In this method, relatively high temperatures can be achieved passively by an elevated outer temperature or else actively by heating.

In a preferred embodiment of the method according to the invention, the flexible tubular casing that is to be dried is conducted through the microwave system at a speed in the range from 0.01 to 30 metres per second, preferably in the range from 0.1 to 10 metres per second, particularly preferably in the range from 0.5 to 5 metres per second.

In the method according to the invention, the flexible tubular casings are dried typically to a residual moisture in the range from 3 to 30%, preferably from 5 to 20%, based on the total weight. The desired residual moisture depends in this case on the type of the artificial casing, but also on the intended use of the casing. The residual moisture is determined gravimetrically (drying in a drying cabinet at 105° C.).

The microwave system used in the method according to the invention is typically dimensioned in such a manner that microwaves are generated in the frequency range between 300 and 300 000 MHz, preferably between 600 and 60 000 MHz, particularly preferably between 900 and 6000 MHz. The radiated power of the microwave system can be 1 to 1000 kW here. However, typically, the radiated power is between 1 and 100 kW, preferably between 1 and 30 kW.

The microwave system used according to the invention can be operated in this case in such a manner that the microwaves are generated, depending on the moisture, before and after the drying process in the continuous mode or in the pulse mode. Thus, e.g. in the pulse mode, with high microwave power, a similarly good drying performance can be achieved as in the continuous mode with reduced microwave power.

The method according to the invention can also be operated in such a manner that, in addition to the microwave drying, a predrying and/or postdrying of the flexible tubular casing proceeds by other drying methods. Such other methods can comprise, e.g., drying by heated air or drying by infrared radiation.

The present invention likewise relates to an integrated system for producing and drying flexible tubular casing, wherein the system comprises at least one subsystem for producing flexible tubular casings and a subsystem for drying the flexible tubular casings produced, characterized in that the subsystem for drying comprises a microwave system.

As in methods already described hereinbefore, the system can also be a system for producing coated or uncoated food casings, wherein they are preferably cellulose fibre skin casings, cellulose skin casings or collagen skin casings. The microwave system used in the integrated system can in this case be constructed in such a manner as is specified in more detail above.

Finally, the present invention relates to the use of microwaves for drying flexible tubular casings, wherein the generation of the microwaves, the drying and the selection of the flexible tubular casings can proceed in accordance with the aforesaid details.

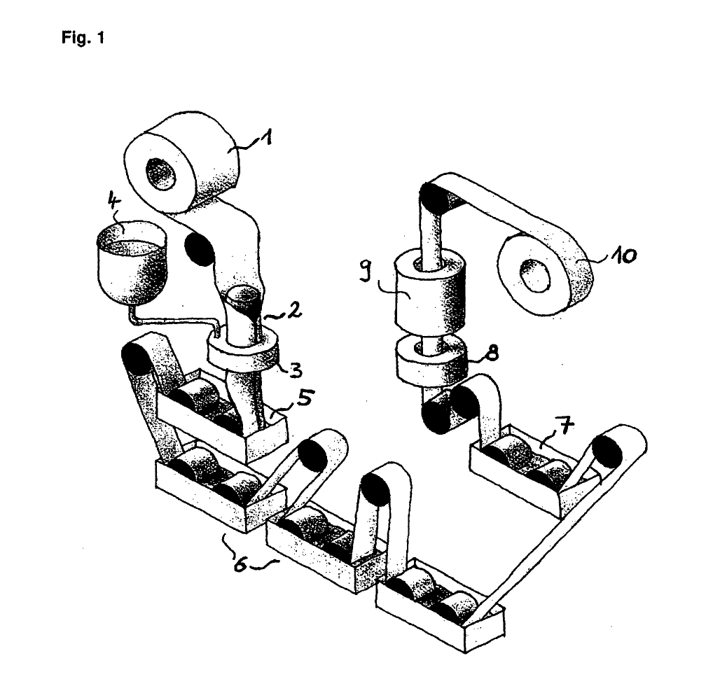

FIG. 1 shows the use according to the invention of a microwave system for drying flexible tubular casings using the example of fibre skin production in an integrated system according to the invention for producing and drying flexible tubular casings.

The fibre skin system shown in FIG. 1 as a representative for other systems according to the invention also comprises a flat fibre felt that can be wound up by a roll 1 and is shaped to form a flexible tube on a flexible tube formation device 2 and is then conducted through a viscosing die 3 where, by introducing viscose 4, a fibre raw skin is formed which, after passing through a precipitation bath 5, a plurality of wash baths 6 and treatment baths 7, is fed to an impregnation station 8. From there, the fibre skin that is thus produced but is still moist is conducted through a microwave system 9 that is open on two sides for drying. The dried fibre skin is then wound up at the station 10.

### EXAMPLE

A dried cellulose fibre skin having adhesive impregnation (Walsroder FR) of calibre 60 was produced by the method according to the invention at a defined system speed, using microwave drying.

50 cm sections of this casing were stuffed tightly with a raw sausage emulsion and processed to completion. After a ripening time of 30 days, no points of detachment occurred, i.e. the casing shrank conjointly very well.

### Comparative Example

A cellulose fibre skin with adhesive impregnation (Walsroder FR) of calibre 60 in accordance with the example above was produced by a customary method and at the same system speed as above using hot air for drying down to the same residual moisture as in the above example. In order to achieve this, the hot air temperature had to be set correspondingly high.

50 cm sections thereof were stuffed tightly with the same raw sausage emulsion and likewise processed to completion. In this case, in the product, points of slight detachment occurred after 30 days, i.e. the casing detached somewhat from the sausage mix.

In addition, a lower weight loss was observed than in the case of the product produced and dried by the method according to the invention. The lower weight loss is a sure indication of cornification of the cellulose surface by excess heat action (c.f. “Holzforschung [Wood Research]—International Journal of the Biology, Chemistry, Physics and Technology of Wood”, volume 33, number 2, pages 33-35, ISSN (Print) 0018-3830, 1979).

### LIST OF REFERENCE SIGNS

(1) Fibrous nonwoven roll

(2) Flexible tube forming device

(3) Viscosing die

(4) Viscose container

(5) Precipitation bath

(6) Wash baths

(7) Treatment baths

(8) Impregnation station

(9) Microwave system

(10) Winding-up station

1. Method for drying flexible tubular food casings, comprising conducting a flexible tubular food casing that is to be dried through a microwave system that generates microwaves.

2. Method according to claim 1, wherein the flexible tubular food casing that is to be dried is a coated or uncoated food casing, wherein either an uncoated moist food casing, a moist coating of a food casing, or a moist food casing provided with a moist coating is dried by the microwaves of the microwave system.

3. Method according to claim 1, wherein the flexible tubular food casing was produced in a wet skin process.

4. Method according to claim 1, wherein the flexible tubular food casing that is to be dried is conducted continuously in an integrated production and drying process, after production thereof, through the microwave system, which is open on at least two sides, wherein the tubular food casing is dried.

5. Method according to claim 1, wherein the drying proceeds inside the microwave system at a temperature in the range between 0 and 200° C., preferably between 20 and 100° C.

6. Method according to claim 1, wherein the flexible tubular food casing that is to be dried is conducted through the microwave system at a speed in the range from 0.01 to 30 meters per second.

7. Method according to claim 1, wherein the flexible tubular food casing is dried to a residual moisture in the range from 3 to 30%.

8. Method according to claim 1, wherein the microwave system generates microwaves in the frequency range between 300 and 30,0000 MHz.

9. Method according to claim 1, wherein the microwaves are generated in the continuous mode or in the pulse mode.

10. Method according to claim 1, wherein the radiated power of the microwave system is between 1 and 1000 kW.

11. Method according to claim 1, wherein, in addition to the microwave drying, a predrying and/or postdrying of the flexible tubular food casing proceeds by other drying methods.

12. Integrated system for producing and drying flexible tubular food casing at least comprising a subsystem for producing flexible tubular food casings and a subsystem for drying the flexible tubular food casings produced, wherein the subsystem for drying comprises a microwave system.

13. System according to claim 12, wherein the system is a system for producing coated or uncoated food casings.

14. System according to claim 12, wherein the microwave system generates microwaves in the frequency range between 300 and 300,000 MHz.

15. (canceled)

16. (canceled)

17. The method according to claim 1, wherein the flexible tubular food casing is selected from the group consisting of cellulose fiber skin, cellulose skin and collagen skin.

18. Method according to claim 1, wherein the flexible tubular food casing that is to be dried is conducted through the microwave system at a speed in the range from 0.5 to 5 meters per second.

19. Method according to claim 1, wherein the flexible tubular food casing is dried to a residual moisture in the range from 5 to 20%

20. Method according to claim 1, wherein the microwave system generates microwaves in the frequency range between 600 and 60,000 MHz.

21. Method according to claim 1, wherein the microwave system generates microwaves in the frequency range between 900 and 6000 MHz.

22. Method according to claim 1, wherein the radiated power of the microwave system is between 1 and 30 kW.

23. System according to claim 13, wherein the food casings are selected from the group consisting of cellulose fiber skin casings, cellulose skin casings and collagen skin casings.

24. System according to claim 12, wherein the microwave system generates microwaves in the frequency range generates microwaves in the frequency range between 600 and 60,000 MHz.

25. System according to claim 12, wherein the microwave system generates microwaves in the frequency range generates microwaves in the frequency range between 900 and 6000 MHz.

26. System according to claim 12, wherein the microwaves are generated in the continuous mode or in the pulse mode

27. System according to claim 12, wherein the radiated power of the microwave system is between 1 and 1000 kW.

28. System according to claim 12, wherein the radiated power of the microwave system is between 1 and 30 kW.
